(19) United States
(12) Patent Application Publication
(10) Pub. No.: US 2024/0092519 A1
(43) Pub. Date: Mar. 21, 2024

(54) IMAGING ASSISTING APPARATUS AND IMAGING ASSISTING METHOD

(71) Applicant: FUJIFILM Toyama Chemical Co., Ltd., Tokyo (JP)

(72) Inventor: Jun SATO, Tokyo (JP)

(73) Assignee: FUJIFILM Toyama Chemical Co., Ltd., Tokyo (JP)

(21) Appl. No.: 18/470,992

(22) Filed: Sep. 20, 2023

(30) Foreign Application Priority Data
Sep. 21, 2022 (JP) 2022-150679

(51) Int. Cl. B65B 57/10; B65B 5/10

(52) U.S. Cl. CPC B65B 57/10; B65B 5/108

(57) ABSTRACT

An imaging assisting apparatus includes: a first member in which a packaging bag containing a drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward the side opposite to the first surface where the packaging bag is placed, and is disposed on a side opposite to the second member across the first member.

### CROSS-REFERENCE TO RELATED APPLICATION

The present application claims priority under 35 U.S.C § 119(a) to Japanese Patent Application No. 2022-150679 filed on Sep. 21, 2022, which is hereby expressly incorporated by reference, in its entirety, into the present application.

### BACKGROUND OF THE INVENTION

### 1. Field of the Invention

The present invention relates to an imaging assisting apparatus and an imaging assisting method.

### 2. Description of the Related Art

Medical institutions such as hospitals differentiate between drugs brought in by persons such as patients. In some cases, brought-in drugs are packaged in one packaging bag. For the packaged brought-in drugs, the drugs may be imaged for each packaging bag and differentiated using the image data of the drugs.

Japanese Patent Application Laid-Open No. 2022-025439 describes a drug identification apparatus that images a drug group containing one or more drugs and identifies the drugs included in the drug group using the image data of the drug group. According to Japanese Patent Application Laid-Open No. 2022-025439, the apparatus images the drug group mounted on a transparent mounting table from the lower side opposite to the drugs on the mounting table. The apparatus includes a cover provided on the side opposite to the mounting table of the drug group.

Japanese Patent Application Laid-Open No. 2016-220911 describes a dispensing auditing apparatus that supports audits for dispensing using image data of drugs to be observed. According to Japanese Patent Application Laid-Open No. 2016-220911, the apparatus images drugs to be observed that are supported using a drug holder mounted on a rotating table. The drugs to be observed are imaged on the front, side, and back surfaces of a PTP sheet. Here, PTP is an abbreviation for press through package.

Japanese Patent Application Laid-Open No. 2016-106647 describes a drug audit supporting apparatus that images drugs packaged in a packaging bag and recognizes the drugs in the packaging bag from the captured image. According to Japanese Patent Application Laid-Open No. 2016-106647, the apparatus includes an L-shaped body housing part and a base part which supports the lower side of the body housing part. The base part has a rectangular planar shape.

International Publication No. 2022/065275 describes a drug recognizing system that identifies drugs to be identified based on a captured image of the drugs to be identified. According to International Publication No. 2022/065275, the apparatus includes a pressing mechanism that presses drugs against a mounting table and adjusts a degree of contact between the drugs and the packaging bag.

### CITATION LIST

Patent Literature 1: Japanese Patent Application Laid-Open No. 2022-025439

Patent Literature 2: Japanese Patent Application Laid-Open No. 2016-220911

Patent Literature 3: Japanese Patent Application Laid-Open No. 2016-106647

Patent Literature 4: International Publication No. 2022/065275

### SUMMARY OF THE INVENTION

However, when drugs packaged in a packaging bag are imaged, environmental light that reaches a surface of the packaging bag may be reflected on the surface of the packaging bag. In this case, the drugs packaged inside the packaging bag may not be sufficiently imaged so that it becomes difficult to identify the drug. The environmental light that reaches the packaging bag includes indoor illumination light and natural light such as sunlight.

None of Japanese Patent Application Laid-Open No. 2022-025439, Japanese Patent Application Laid-Open No. 2016-220911, Japanese Patent Application Laid-Open No. 2016-106647, and International Publication No. 2022/065275 describes or suggests the problem of reflection of the environmental light on the surface of the packaging bag. Moreover, Japanese Patent Application Laid-Open No. 2022-025439, etc. do not disclose an invention for solving the problems.

The present invention has been made in view of such circumstances. The present invention aims to provide an imaging assisting apparatus and an imaging assisting method that suppress influence of environmental light when imaging drugs so as to favorably image the drugs.

An imaging assisting apparatus according to a first aspect includes: a first member in which a packaging bag containing a drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward the side opposite to the first surface where the packaging bag is placed, and is disposed on a side opposite to the second member across the first member.

The imaging assisting apparatus according to the first aspect includes the second member which suppresses the incidence of environmental light on the packaging bag placed on the first member. This makes it possible to image the drug while suppressing reflection of environmental light on the surface of the packaging bag.

According to a second aspect, in the imaging assisting apparatus of the first aspect, the third member has a leg part to be used in a case where the imaging assisting apparatus is installed, and the leg part is configured in such a manner that the imaging assisting apparatus may be installed in an attitude in which: a normal line of the first surface has a horizontal component; and a direction in which the second member extends has a component in a direction of the normal line.

In the second aspect, the third member has the leg part for placing the imaging assisting apparatus. This achieves installation of the imaging assisting apparatus in an attitude such that the normal line of the first surface has a horizontal component and the direction in which the second member extends has a component in the direction of the normal line.

The third member may include a member that functions as a leg part, or the third member may have a structure and shape in which a surface provided in the third member functions as the leg part.

According to a third aspect, in the imaging assisting apparatus of the first or the second aspect, the second member includes a side surface member extending in a direction perpendicular to a direction in which the second member extends.

In the third aspect, it is possible to enhance suppression of environmental light incident from the direction perpendicular to the extending direction of the second member.

According to a fourth aspect, in the imaging assisting apparatus of the third aspect, in the second member, an end of the side surface member is joined to an end of the third member in a direction perpendicular to a direction in which the third member extends.

In the fourth aspect, the first member is covered over the entire circumference. This enhances suppression of light incident on the packaging bag placed on the first member.

According to a fifth aspect, in the imaging assisting apparatus of the third or the fourth aspect, a distal end of the second member is disposed farther from the first member than a distal end of the third member.

In the fifth aspect, it is possible to enhance suppression of incidence of light incident from the side of the second member.

According to a sixth aspect, in the imaging assisting apparatus of any one of the first to the fifth aspects, the second member has a structure in which an angle formed between the second member and the first surface is more than 90 degrees.

In the sixth aspect, in adjusting the imaging range of the imaging apparatus including adjustment of an orientation to the object to be imaged and a distance between the imaging apparatus and the object, the second member does not obstruct the adjustment. Thus. it is easy to adjust the imaging range.

According to a seventh aspect, in the imaging assisting apparatus of any one of the first to the sixth aspects, the third member has a structure in which an angle formed between the third member and the first surface is more than 90 degrees.

In the seventh aspect, when the imaging assisting apparatus is installed in a direction in which the third member becomes horizontal, it is possible to make the imaging apparatus to face the packaging bag placed on the first member, from diagonally above. For example, it is assumed that the imaging assisting apparatus is installed on a workbench such as a desk and a cameraman is in a seated posture on a chair. In this case, because the cameraman's eyes and the drug to be imaged is connected by a straight line through the viewfinder of the camera, the cameraman's line of sight is lowered. When the surface of the object to be imaged is at an elevation angle, the cameraman can take an image on that line, so that he/she does not have to change his/her posture. Thus, it is possible to facilitate imaging.

According to an eighth aspect, in the imaging assisting apparatus of any one of the first to the seventh aspects, the third member has a structure in which an angle formed between the third member and the first surface is 120 degrees or more.

In the eighth aspect, the packaging bag placed on the first member can be relatively inclined downward. Thus, it is possible to adjust the imaging range more easily, and it is possible to suppress falling of the drug inside the packaging bag and uneven distribution of the drug to a lower part of the packaging bag.

According to a ninth aspect, in the imaging assisting apparatus of any one of the first to the eighth aspects, the first member includes a movement suppressing mechanism configured to suppress movement of the drug contained in the packaging bag.

In the ninth aspect, it is possible to suppress falling of the drug inside the packaging bag placed on the first member.

According to a tenth, in the imaging assisting apparatus of the ninth aspect, the movement suppressing mechanism includes a pressing member configured to press the packaging bag toward the first surface.

In the tenth aspect, the position of the drug can be fixed inside the bag placed on the first member.

According to an eleventh aspect, in the imaging assisting apparatus of the tenth aspect, the pressing member is disposed on a first facing surface which faces the first surface.

In the eleventh aspect, the bag can be pressed toward the first surface from the side facing the first surface.

According to a twelfth aspect, in the imaging assisting apparatus of the eleventh aspect, the first facing surface has: a shape corresponding to a planar shape of the first surface; and a through hole formed at a position corresponding to the first surface, and the pressing member is disposed around the through hole of the first facing surface.

In the twelfth aspect, the circumferential part of the packaging bag placed on the first member is pressed. This reduces the stress on the drug caused by pressing of the packaging bag. In addition, this prevents the pressing member from being imaged.

According to a thirteenth aspect, in the imaging assisting apparatus of any one of the tenth to the twelfth aspects, the pressing member is made using an elastic member.

In the thirteenth aspect, a preferable pressing force can be applied to the packaging bag placed on the first member.

According to a fourteenth aspect, in the imaging assisting apparatus of any one of the tenth to the thirteenth aspects, the movement suppressing mechanism includes a cushioning member disposed at a position where the packaging bag is pressed on the first surface by the pressing member.

In the fourteenth aspect, it is possible to enhance suppression of falling of the drug inside the packaging bag placed on the first member.

According to a fifteenth, in the imaging assisting apparatus of any one of the ninth to the fourteenth aspects, the first surface has a plurality of protrusions.

In the fifteenth aspect, it is possible to enhance suppression of falling of the drug inside the packaging bag placed on the first member.

According to a sixteenth aspect, in the imaging assisting apparatus of any one of the ninth to the fourteenth aspects, the first surface has a shape in which a center is convex with respect to an edge.

In the sixteenth aspect, it is possible to enhance suppression of falling of the drug inside the packaging bag placed on the first member.

According to a seventeenth aspect, in the imaging assisting apparatus of any one of the ninth to the sixteenth aspects, the first surface has a plurality of convex parts which respectively extend in a direction in which the packaging bag is inserted into the first member, and the plurality of convex parts are arranged to be spaced apart from each other, along a direction that is parallel to the first surface and perpendicular to a direction in which the plurality of convex parts extend.

In the seventeenth aspect, it is possible to enhance suppression of falling of the drug inside the packaging bag placed on the first member.

An eighteenth aspect is an imaging assisting method for assisting imaging of a drug using an imaging assisting apparatus, wherein the imaging assisting apparatus includes: a first member in which a packaging bag containing the drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward a side opposite to the first surface where the packaging bag is placed, and is disposed on a side opposite to the second member across the first member. The imaging assisting method includes: placing the packaging bag containing the drug, in the first member of the imaging assisting apparatus installed in an attitude where the first surface is directed in a vertically upward direction; fixing a position of the packaging bag placed on the first surface; and changing an attitude of the imaging assisting apparatus in which the packaging bag is fixed to the first surface, from the attitude where the first surface is directed in the vertically upward direction, to an attitude where the first surface is directed in a direction intersecting the vertically upward direction, to assist the imaging of the drug.

The imaging assisting method according to the eighteenth aspect can achieve the same actions and effects as those of the imaging assisting apparatus according to the first aspect.

In the eighteenth aspect, the same matters as those specified in the second to the seventeenth aspects can be appropriately combined. In that case, the components responsible for the processes and functions specified in the imaging assisting apparatus can be understood as the components of the imaging assisting method responsible for the corresponding processes and functions.

A nineteenth aspect is an imaging assisting method for assisting imaging of a drug using an imaging assisting apparatus, wherein the imaging assisting apparatus includes: a first member in which a packaging bag containing the drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward a side opposite to the first surface where the packaging bag is placed, and is disposed on a side opposite to the second member across the first member. The imaging assisting method includes: causing at least a part of the third member to function as a leg part; and assisting the imaging of the drug, using the imaging assisting apparatus installed in an attitude where the first surface is directed in a direction intersecting a vertically upward direction.

The imaging assisting method according to the nineteenth aspect, can achieve the same actions and effects as those of the imaging assisting apparatus according to the first aspect.

In the nineteenth aspect, the same things as those specified in the second to the seventeenth aspects can be appropriately combined. In that case, the components responsible for the processes and functions specified in the imaging assisting apparatus can be understood as the components of the imaging assisting method responsible for the corresponding processes and functions.

According to the present invention, the second member is provided for suppressing the incidence of environmental light on the packaging bag placed on the first member. This makes it possible to image the drug while suppressing reflection of environmental light on the surface of the packaging bag.

### BRIEF DESCRIPTION OF THE DRAWINGS

FIG. 1 is a perspective view showing an imaging state of an imaging assisting apparatus according to an embodiment;

FIG. 2 is a perspective view showing a placement state of drugs in the imaging assisting apparatus according to the embodiment;

FIG. 3 is a perspective view of the imaging assisting apparatus shown in FIG. 1;

FIG. 4 is a perspective view of the imaging assisting apparatus shown in FIG. 2;

FIG. 5 is a front view of the imaging assisting apparatus shown in FIG. 1;

FIG. 6 is a top view of the imaging assisting apparatus shown in FIG. 1;

FIG. 7 is a bottom view of the imaging assisting apparatus shown in FIG. 1;

FIG. 8 is a left side view of the imaging assisting apparatus shown in FIG. 1;

FIG. 9 is a right side view of the imaging assisting apparatus shown in FIG. 1;

FIG. 10 is a rear view of the imaging assisting apparatus shown in FIG. 1;

FIG. 11 is a schematic diagram showing a modification of a marker shown in FIG. 5;

FIG. 12 is a schematic diagram showing another modification of the marker shown in FIG. 5;

FIG. 13 is a vertical cross-sectional view of the imaging assisting apparatus;

FIG. 14 is a perspective view of an imaging assisting apparatus according to a first modification;

FIG. 15 is a perspective view of an imaging assisting apparatus according to another aspect of the first modification;

FIG. 16 is a perspective view of an imaging assisting apparatus according to a second modification;

FIG. 17 is a schematic diagram of an imaging assisting apparatus according to a third modification;

FIG. 18 is an explanatory diagram of a first modification of a placing surface;

FIG. 19 is an explanatory diagram of a second modification of the placing surface;

FIG. 20 is an explanatory diagram of a third modification of the placing surface;

FIG. 21 is an explanatory diagram of a fourth modification of the placing surface; and

FIG. 22 is a schematic diagram of an imaging assisting apparatus according to a fifth modification.

### DESCRIPTION OF THE PREFERRED EMBODIMENTS

The following describes preferred embodiments of the present invention in detail with reference to the accompanying drawings. In the present description, the same components are designated by the same reference sign, and duplicate descriptions are omitted as appropriate.

### [Outline of Imaging Assisting Apparatus According to Embodiment]

### [Overall Configuration]

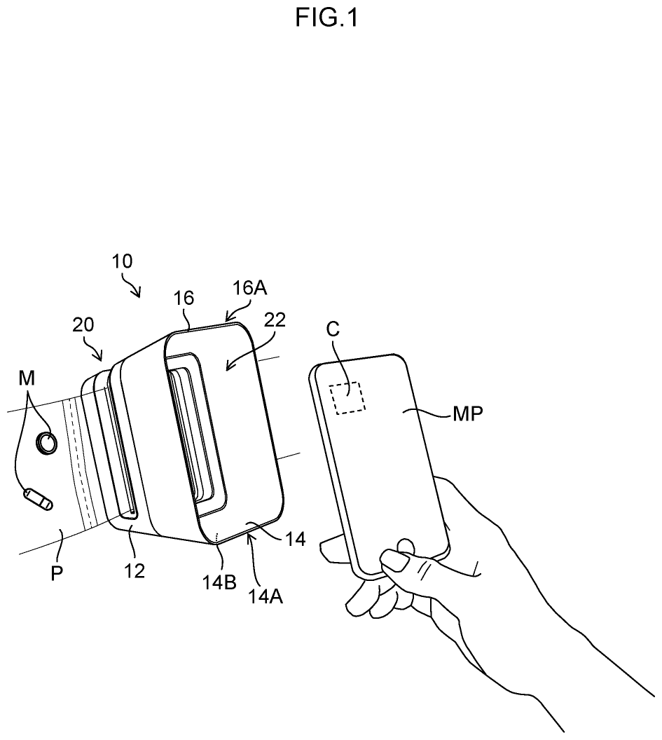

FIG. 1 is a perspective view showing an imaging state of an imaging assisting apparatus according to an embodiment. When packaged drugs M are imaged with a camera C from outside of a packaging bag P that contains the drugs M, an imaging assisting apparatus 10 is used for suppressing incidence of environmental light on the packaging bag P. FIG. 1 illustrates a camera included in a mobile terminal apparatus MP, as an example of the camera C.

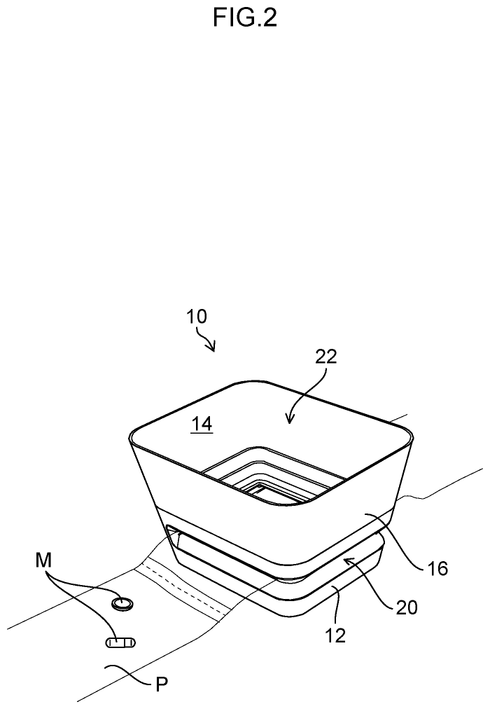

For convenience of illustration, FIG. 1 does not show the packaging bag P and the drugs M being imaged by the camera C. Reference signs are given to: packaging bags P that are continuous with the packaging bag P containing the drugs M being imaged by the camera C; and drugs M contained inside the packaging bag P. The same applies to the packaging bag P and the drugs M shown in FIG. 2.

Here, the environmental light may include various lights in the environment where the imaging assisting apparatus is installed, such as indoor illumination light and natural light such as sunlight. The camera C just needs to be an imaging apparatus capable of taking still images, or may be the one additionally capable of taking moving images.

The drugs M include tablets and capsules. The packaging bag P may be transparent, or may be partially transparent and partially opaque. The packaging bag P may be transparent on both the front and back surfaces, or may be opaque in part of area on the front or back surface.

The term “transparent” just needs to be a certain degree of light transmission that allows imaging of the drugs M contained in the packaging bag P. The term “opaque” may be a certain degree of light transmission that makes it possible to see the drugs M contained in the packaging bag P but makes it difficult to image the drugs M contained therein. Examples of opaque areas include the background of areas where dates, medical institution names, patient names, dosing timings, drug names, etc. are printed.

Image data of the drugs imaged with the imaging assisting apparatus 10 is used for identifying the drugs. Identification data obtained by identifying the drugs is used for drug differentiation. The identification data may be used for audit of the drugs.

The imaging assisting apparatus 10 shown in FIG. 1 includes a placing member 12, a leg member 14 and a light suppressing member 16. The leg member 14 and the light suppressing member 16 have a structure which radially extends from sides forming the outer circumference of the placing member 12 having a quadrangular shape. Here, the quadrangular shape may be a shape in which the vertex corners of the quadrangle are replaced with arcs.

The imaging assisting apparatus 10 has a truncated quadrangular pyramid shape as a whole. On one bottom surface of the truncated quadrangular pyramid, there is disposed the placing member 12 on which the packaging bag P containing the drugs M is placed. The other bottom surface of the truncated quadrangular pyramid forms a first opening 22 surrounded by a distal end 14A of the leg member 14 and a distal end 16A of the light suppressing member 16. Here, each oblique side of the truncated quadrangular pyramid may be formed as a chamfered curved surface as shown in FIG. 1, or may be a non-chamfered side.

In a case where an end of the leg member 14 on the side of the placing member 12 is defined as a proximal end, a distal end 14A of the leg member 14 is the end opposite to the proximal end. Likewise, in a case where an end of the light suppressing member 16 on the side of the placing member 12 is defined as a proximal end, a distal end 16A of the light suppressing member 16 is the end opposite to the proximal end.

In the imaging assisting apparatus 10, one of the four slopes forming the truncated quadrangular pyramid functions as the leg member 14, and the three slopes other than the slope functioning as the leg member 14 function as the light suppressing member 16.

An outer surface 14B of the leg member 14 may have a member (members) having a non-slip function such as a rubber leg (rubber legs) attached thereon. The outer surface 14B of the leg member 14 may have a member (members) having a movement assisting function such as a caster (casters) attached thereon. It is preferable that the casters have a brake function.

The outer surface 14B of the leg member 14 may be subjected to surface treatment such as anti-slip treatment in order to ensure a stable attitude of the imaging assisting apparatus 10. In a case where the imaging assisting apparatus 10 is installed on a workbench in the attitude shown in FIG. 1, the outer surface 14B of the leg member 14 is a surface which faces downward (which is directed downward) and is in contact with the workbench.

In the imaging assisting apparatus 10, the packaging bag P is inserted into a groove 20 of the placing member 12, and the packaging bag P is fixed at a specified position, with a placing surface used as a support surface. In a case where the drugs M contained inside the packaging bag P are imaged, the imaging assisting apparatus 10 is in an attitude such that the leg member 14 is directed downward and the first opening 22 is directed frontward.

The term “down” here represents a direction having a vertically downward component in a case where the imaging assisting apparatus 10 is installed on a plane parallel to a horizontal plane which is perpendicular to the vertical direction. Likewise, the term “up” represents a direction having a vertically upward component in a case where the imaging assisting apparatus 10 is installed on the plane parallel to the horizontal plane. The term “up and down” may represent relative directional relationships. Further, the term “front” represents the side on which the camera C is positioned.

Here, regarding the planes parallel to the horizontal plane, the term “parallel” is not limited to “strictly parallel”. The “planes parallel to the horizontal plane” may include substantially parallel planes that can be regarded as parallel from the viewpoint of the functions and effects, etc., even in a case where the planes actually intersect with the horizontal plane.

FIG. 2 is a perspective view showing a placement state of the drugs in the imaging assisting apparatus according to the embodiment. In FIG. 2, some of the reference signs shown in FIG. 1 are omitted as appropriate. FIG. 2 shows a state in which the imaging assisting apparatus 10 is installed in a state where the placing member 12 is directed downward and the first opening 22 is directed upward. When the packaging bag P is placed in the imaging assisting apparatus 10, the imaging assisting apparatus 10 is in an attitude such that the placing member 12 is directed downward and the first opening 22 is directed upward. The packaging bag P is inserted into the groove 20 from the front side in FIG. 2, and then is abutted against the back side surface of the groove 20 to be fixed.

In a state where the packaging bag P is inserted into the groove 20 and fixed thereto, the imaging assisting apparatus 10 is rotated from the front side to the back side in FIG. 2 with the leg member 14 used as a fulcrum, so that the imaging assisting apparatus 10 is brought into an attitude with the leg member 14 directed downward as shown in FIG. 1.

Note that the placing member 12 described in the embodiment is an example of a first member. The light suppressing member 16 described in the embodiment is an example of a second member. The leg member 14 described in the embodiment is an example of a third member. The groove 20 described in the embodiment is an example of a structure in which a packaging bag is placed. The change from the attitude of the imaging assisting apparatus 10 shown in FIG. 1 to the attitude of the imaging assisting apparatus 10 shown in FIG. 2 is an example of a step included in the imaging assisting method.

### [Structure Example of Imaging Assisting Apparatus]

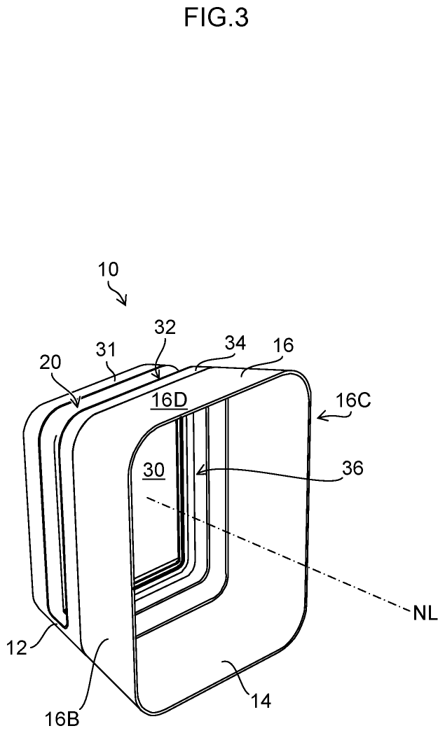

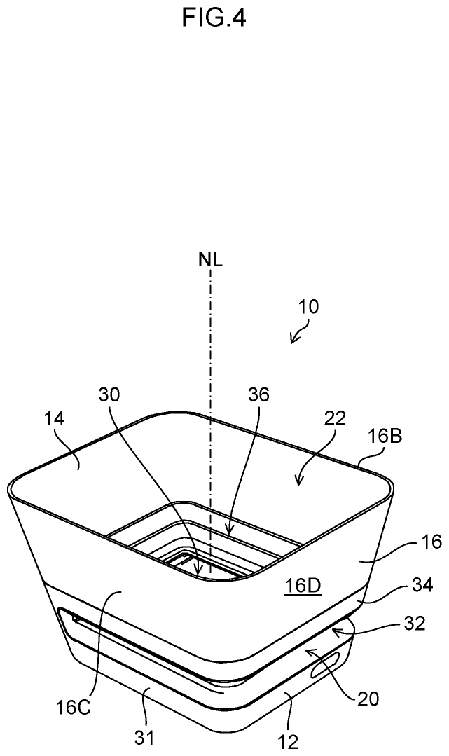

FIG. 3 is a perspective view of the imaging assisting apparatus shown in FIG. 1. FIG. 4 is a perspective view of the imaging assisting apparatus shown in FIG. 2. The placing member 12 includes a placing surface member 31 having a placing surface 30. The placing member 12 further includes a placement facing surface member 34 having a placement facing surface 32 that faces the placing surface 30. The placing surface 30 and the placement facing surface 32 are parallel to each other. The groove 20 of the placing member 12 is a space between the placing surface 30 and the placement facing surface 32. The groove 20 of the placing member 12 is a through groove penetrating the placing member 12 in the lateral direction in FIG. 3.

The placement facing surface member 34 has a second opening 36 penetrating the placement facing surface member 34 in the thickness direction. The thickness direction of the placement facing surface member 34 is the direction of the normal line NL of the placing surface 30.

The shape surrounded by the sides forming the second opening 36 is a shape corresponding to the planar shape of the placing surface 30, The second opening 36 has a size corresponding to the placing surface 30 and a position corresponding to the placing surface 30. For example, the shape surrounded by the sides which form the second opening 36, may be similar to the planar shape of the placing surface 30. The second opening 36 has a position, planar shape, and size that may expose the entire area in which the drugs M can be exist in a case where the drugs M contained in the packaging bag P are imaged from the first opening 22.

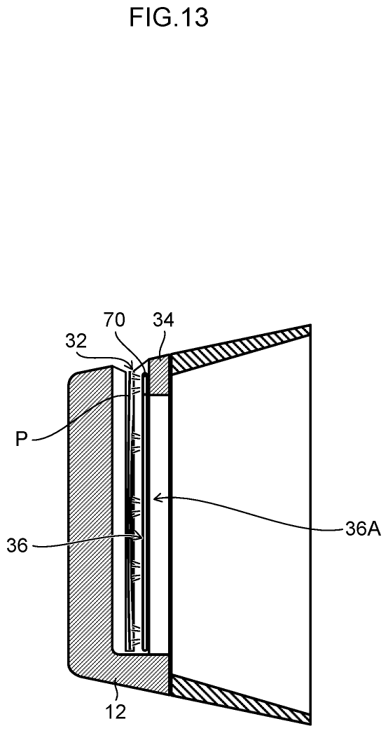

In the placement facing surface member 34, a lighting device is attached around the second opening 36. Here, in FIGS. 3 and 4, the lighting device is not shown. The lighting device is shown in FIG. 13 with a reference sign 70.

In a case where the imaging assisting apparatus 10 shown in FIG. 3 is installed on a plane parallel to the horizontal plane with the leg member 14 facing downward, the imaging assisting apparatus 10 is in an attitude such that the direction of the normal line NL of the placing surface 30 has a horizontal component. In the imaging assisting apparatus 10 in the attitude shown in FIG. 3, the light suppressing member 16 has a structure which extends from at least a part of the placing member 12 and whose entire body has a component in the direction of the normal line NL of the placing surface 30. In the direction perpendicular to the normal direction XL of the placing surface 30, the leg member 14 is disposed on a side opposite to an upper surface member 16D of the light suppressing member 16, with respect to the placing member 12. In the direction perpendicular to the normal direction XL of the placing surface 30, the leg member 14 and the upper surface member 16D are separated from each other, with the placing member 12 disposed therebetween.

In other words, the leg member 14 has a shape extending from the placing member 12 toward a side opposite to the placing surface 30. Likewise, the light suppressing member 16 as a whole has a shape which extends from the placing member 12 toward the side opposite to the placing surface 30. FIGS. 3 and 4 illustrate a case where: the direction in which the light suppressing member 16 extends is not parallel to the direction in which the leg member 14 extends; and the angle formed by the light suppressing member 16 and the leg member 14 is greater than 0 degree.

The light suppressing member 16 provided in the imaging assisting apparatus 10 shown in FIG. 3, includes a first side surface member 16B and a second side surface member 16C which respectively extend in a side direction perpendicular to the direction in which the upper surface member 16D extends. In the first side surface member 16B and the second side surface member 16C, ends on a side opposite to the upper surface member 16D are joined (connected) to the leg member 14.

Note that the placing surface 30 described in the embodiment is an example of a first surface. The placement facing surface 32 described in the embodiment is an example of a first facing surface. The first side surface member 16B and the second side surface member 16C described in the embodiment are examples of side surface members.

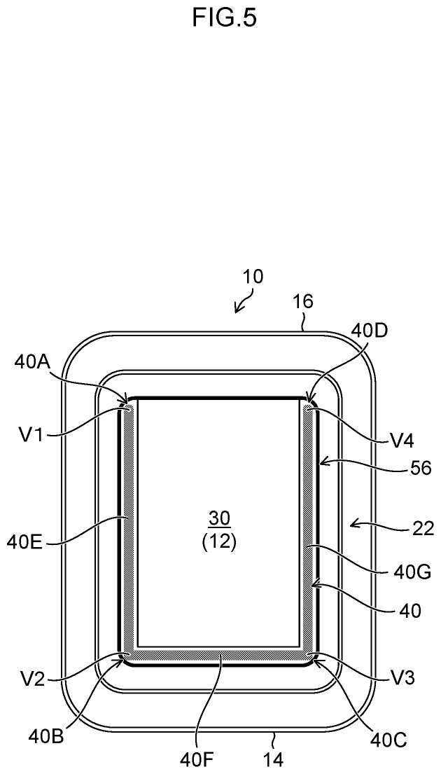

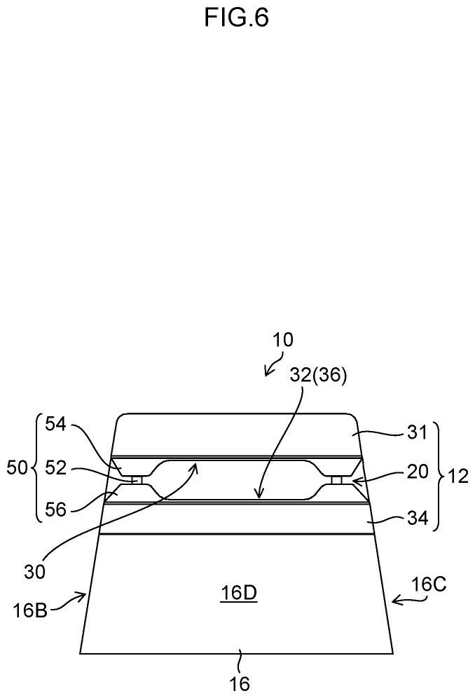

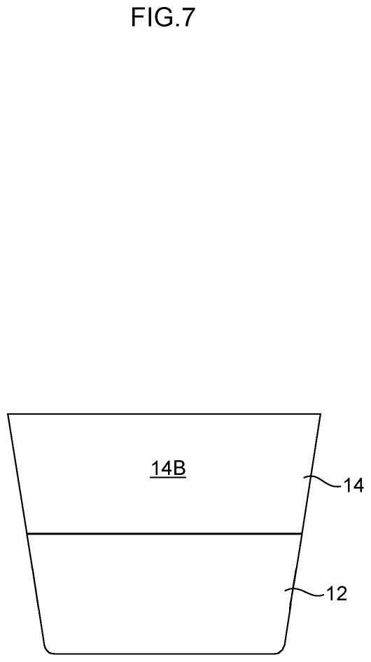

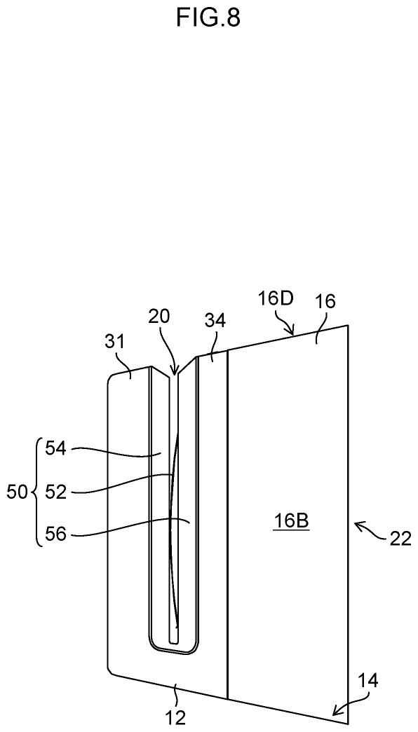

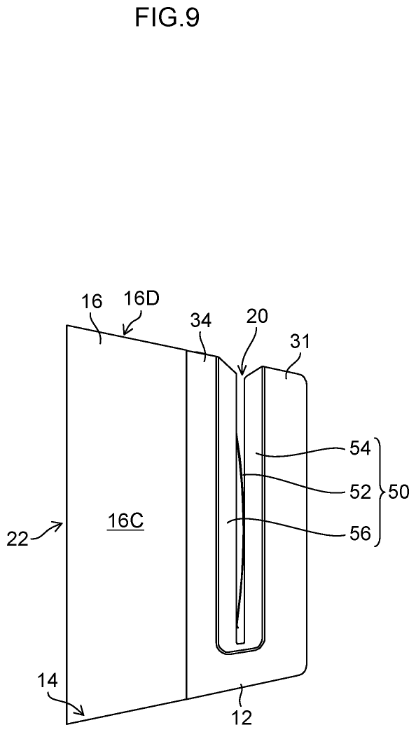

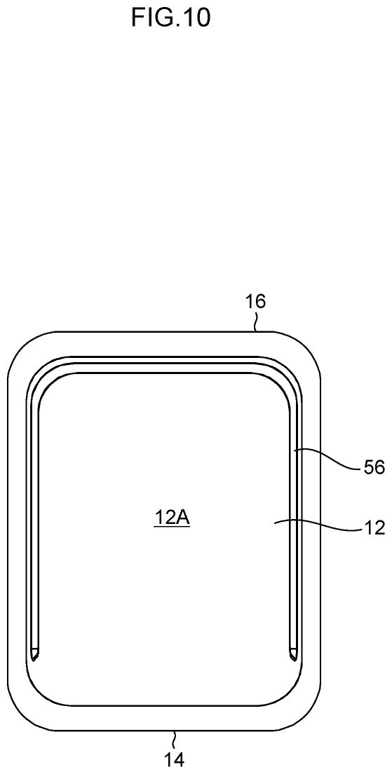

FIG. 5 is a front view of the imaging assisting apparatus shown in FIG. 1. FIG. 6 is a top view of the imaging assisting apparatus shown in FIG. 1. FIG. 7 is a bottom view of the imaging assisting apparatus shown in FIG. 1. FIG. 8 is a left side view of the imaging assisting apparatus shown in FIG. 1. FIG. 9 is a right side view of the imaging assisting apparatus shown in FIG. 1. FIG. 10 is a rear view of the imaging assisting apparatus shown in FIG. 1.

The names of the drawings such as the front view described above use the names of the relative surfaces in a case where FIG. 5 is regarded as the front view. In FIGS. 5 to 10, the reference signs shown in FIGS. 1 to 4 are omitted as appropriate.

In the front view shown in FIG. 5, it is possible to recognize the imaging range when the drugs M are imaged. The placing surface 30 of the placing member 12 is the maximum imaging range. FIGS. 6, 8 and 9 show a fixing structure 50 for fixing the packaging bag P. Note that illustration of the packaging bag P is omitted in FIG. 6, etc.

As shown in FIG. 5, the imaging assisting apparatus 10 includes a marker 40. The marker 40 may be formed by printing. The marker 40 is provided on a surface which is on a side opposite to a surface on which a leaf spring supporting member 56 that fixes the packaging bag P is attached. The details of the leaf spring supporting member 56 and the arrangement of the leaf spring is to be described later.

The marker 40 shown in FIG. 5 defines a vertex V1, a vertex V2, a vertex V3, and a vertex V4 as four vertices. In the marker 40 shown in FIG. 5, ends 40A and 40D are semicircular, and the vertex V1 corresponding to the end 40A and the vertex V4 corresponding to the end 40D are respectively at positions of the centers of the semicircles. The vertices V1, etc. shown in FIG. 5 are illustrated for convenience of descriptions, and the actual marker 40 does not have dots or the like representing the vertices V1, etc.

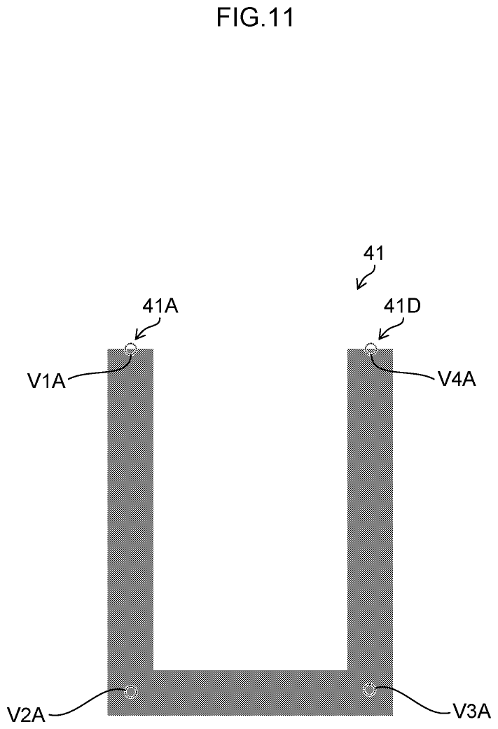

Although FIG. 5 illustrates the marker 40 having the ends 40A and 40D each in a semicircular shape, the marker 40 may have the ends 40A, etc. each in a flat shape. FIG. 11 is a schematic diagram showing a modification of the marker shown in FIG. 5. FIG. 11 illustrates a marker 41 having ends 41A and 41D each in a flat shape.

The marker 41 shown in FIG. 11 has the ends 41A and 41D each in a flat shape. A vertex VIA is at a position of the end 41A of the marker 41 and is defined as the position of the midpoint in the width direction. Likewise, a vertex V4A is at a position of the end 41D of the marker 41 and is defined as the position of the midpoint in the width direction.

In the marker 40 shown in FIG. 5, the vertex V2 of a corner part 40B is at the position of the midpoint in the width direction of a side part 40E having a rectangular shape, and defined as the position of the midpoint in the width direction of a side part 40F having a rectangular shape. Likewise, the vertex V3 of a corner part 40C is at the position of the midpoint in the width direction of the side part 40F having a rectangular shape, and defined as the position of the midpoint in the width direction of a side part 40G having a rectangular shape. The same applies to a vertex V2A and a vertex V3A in the marker 41 shown in FIG. 11. The width direction of each of the side parts 40E, etc. may be the direction perpendicular to the direction in which the side parts 40E, etc. extend. The same applies to the marker 41 shown in FIG. 11.

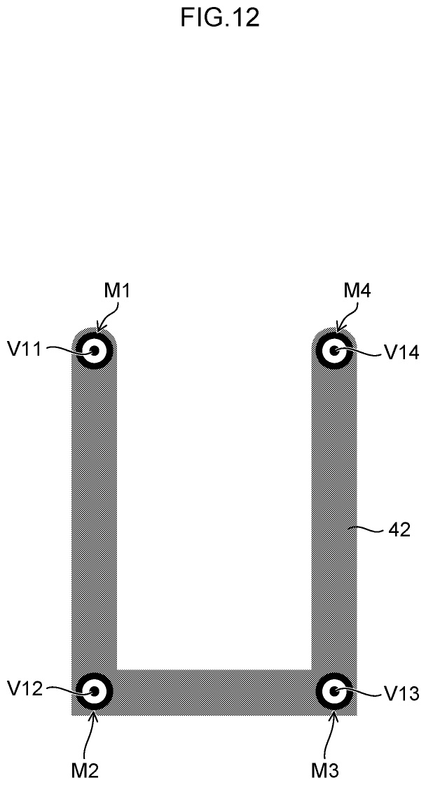

FIG. 12 is a schematic diagram showing another modification of the marker shown in FIG. 5. A marker 42 shown in FIG. 12 includes a vertex marker M1 for a vertex V11. The marker 42 further includes a vertex marker M2, a vertex marker M3, and a vertex marker M4 for a vertex V12, a vertex V13, and a vertex V14, respectively.

Each of the vertex marker M1, the vertex marker M2, the vertex marker M3, and the vertex marker M4 includes a dot placed at its center position and a hollow circle surrounding the dot. In other words, concentric double circles may be applied to the vertex markers M1, etc.

The captured image of the marker 40 shown in FIG. 5 functions as a reference for standardizing the imaging distance and the imaging viewpoint based on the captured image obtained by imaging of the drugs M to be imaged and the marker 40. The captured image obtained by imaging the drugs M to be imaged together with the marker 40 is subjected to image processing, and the coordinates of the four vertices of the marker 40 are acquired based on the captured image.

First, the vertex V1, the vertex V2, the vertex V3, and the vertex V4 of the marker 40 respectively have specified coordinates. Coordinates of positions of the vertex V1, the vertex V2, the vertex V3, and the vertex V4 of the marker 40 after standardization of the imaging distance and the imaging viewpoint, are designated. Then, a perspective transformation matrix is determined so that the vertex V1, the vertex V2, the vertex V3, and the vertex V4, having specified coordinates, are transformed to the positions of the designated coordinates. Such a perspective transformation matrix is uniquely determined as long as there are four points. For example, with a getPerspectiveTransform function of OpenCV, a perspective transformation matrix can be obtained as long as there is a correspondence relationship between the four points.

With the determined perspective transformation matrix, the entire original captured image is subjected to perspective transformation to acquire the image after the perspective transformation. Such a perspective transformation can be executed with a warpPerspective function of OpenCV. The image after this perspective transformation is a standardized image in which the imaging distance and the imaging viewpoint are standardized.

The vertex markers M1, etc. shown in FIG. 12 are examples. The vertex markers may have various shapes. For example, the vertex markers M1, etc. may be quadrangles or may be ArUco markers. In a case where the vertex markers M1, etc. each have a circular shape or a quadrangle shape, it is better that there are a plurality of vertex markers M1, etc. In a case where the vertex markers M1, etc. are in circular shapes, it is preferable that the vertex markers M1, etc. be concentric circles. Also, in a case where the vertex markers M1, etc. are quadrangles, it is preferable that the vertex markers M1, etc. be concentric quadrangles.

The marker 40 may be colored in a color other than black shown in FIG. 5. It is preferable that the color of the marker 40 be white, green, yellow, or any other colors that are compatible with imaging with a camera and human visibility. In particular, it is preferable to use a color that is easy to distinguish from the reflection of the packaging bag P containing the drugs packaged together for one-dose. Examples of colors that can be easily distinguished from the reflection of the packaging bag P include green, yellow, and orange. The same applies to the marker 41 shown in FIG. 11.

FIG. 7 shows a structure of the outer surface 14B of the leg member 14. FIG. 10 shows a structure of a back surface 12A of the placing member 12 on the side opposite to the placing surface 30. The fixing structure 50 shown in FIG. 6, etc. includes a leaf spring 52, a contacting member 54, and the leaf spring supporting member 56.

The leaf spring 52 applies a pressing force to the packaging bag P toward the placing surface 30. The leaf spring 52 is attached around the second opening 36 in the placement facing surface member 34 via the leaf spring supporting member 56. Note that the second opening 36 described in the embodiment is an example of a through hole formed in the first facing surface.

The fixing structure 50 includes two leaf springs 52. One of the two leaf springs 52 is disposed at the end of the light suppressing member 16 on the side of the first side surface member 16B, and the other is disposed at the end of the light suppressing member 16 on the side of the second side surface member 16C.

The contacting member 54 is attached around the placing surface 30 of the placing surface member 31. The arrangement of the contacting member 54 on the placing surface member 31 corresponds to the arrangement of the leaf spring 52 on the placement facing surface member 34. The circumferential part of the packaging bag P is inserted (sandwiched) between the leaf spring 52 and the contacting member 54, and the leaf spring 52 applies a pressing force to the packaging bag P toward the placing surface 30.

The back surface 12A of the placing member 12 shown in FIG. 10 may include a stand (not shown). The stand functions as a leg that supports the back surface 12A of the imaging assisting apparatus 10 and stabilizes the attitude of the imaging assisting apparatus 10 when the drugs M are imaged. The stand may be contained inside the back surface 12A of the imaging assisting apparatus 10 when the drugs M are placed.

FIGS. 1 to 10 show an aspect in which: the leg member 14 and the light suppressing member 16 are configured integrally; and the leg member 14 and the light suppressing member 16 integrally configured are attached to the placing member 12. In contrast, the placing member 12, the leg member 14, and the light suppressing member 16 may be configured as separate members, and the leg member 14 may be attached to the placing member 12, and the light suppressing member 16 may be attached to the placing member 12.

The leg member 14 and the light suppressing member 16 may be attached to the placing member 12 by mechanical fitting or bonding. The imaging assisting apparatus 10 may be configured in such a manner that at least one of the leg member 14 and the light suppressing member 16 is detachable from the placing member 12.

FIG. 13 is a vertical cross-sectional view of the imaging assisting apparatus. FIG. 13 shows a vertical section of the imaging assisting apparatus 10 shown in FIG. 3. The vertical section here is a section having a section line perpendicular to the placing surface 30 and passing through the leg member 14.

The placing member 12 includes a lighting device 70 that irradiates the drugs M with illumination light when the drugs M are imaged.

The lighting device 70 is disposed around the second opening 36 in the placement facing surface 32 of the placement facing surface member 34. As the lighting device 70, a lighting device on which LED elements are arranged, may be used. The lighting device 70 has a filter in front of the LED elements to reduce the light intensity distribution. FIG. 13 shows a part of the lighting device 70. The lighting device 70 may be disposed in an interior 36A of the second opening 36.

The lighting device 70 is disposed at a position where the entire packaging bag P containing the drugs M placed on the placing member 12 may be uniformly illuminated. For example, in a case where the maximum thickness of the drugs M is about 9 mm, the lighting device 70 may be disposed at a position where the distance from the packaging bag P containing the drugs M is 10 mm or more and 20 mm or less. The distance between the lighting device 70 and the packaging bag P may be appropriately defined depending on the thickness of the drugs M.

The leg member 14 and the light suppressing member 16 provided in the imaging assisting apparatus 10 are made of a material having light-blocking properties against the environmental light. Examples of the materials for the leg member 14 and the light suppressing member 16 include resin materials and metal materials. Here, the light-blocking properties are not limited to a performance of completely blocking the transmission of light. The light-blocking properties may be a performance of blocking at least part of the light as long as the imaging of the drugs M is not hindered.

It is preferable that the placing member 12, the leg member 14, and the light suppressing member 16, which are provided in the imaging assisting apparatus 10, have inner surfaces colored in a color that suppresses reflection of environmental light. Examples of colors applied to the inner surfaces of the leg member 14 and the light suppressing member 16 include black, matte black, and gray.

The leg member 14 and the light suppressing member 16 may be made of a material that itself has light-blocking properties against environmental light. Alternatively, the leg member 14 and the light suppressing member 16 may be provided with light-blocking properties against natural light through application of a surface treatment such as painting to a material having light transmission.

FIG. 13 illustrates an aspect in which: the lighting device 70 is disposed on the same side as the camera C with respect to the placing surface 30; and the camera C receives the reflected light of the illumination light applied to the drugs M. However, an aspect may also be applied in which: the lighting device 70 is disposed on the side opposite to the camera C with respect to the placing surface 30; and the camera C receives the light transmitted through the drugs M. Imaging of the drugs M through the backlight makes it possible to acquire an image in which the engraved mark (stamp, or imprint) on the tablet stands out. Imaging of the drugs M through the backlight is effective in a case where the front surface and back surface of the packaging bag are opaque.

The illumination light emitted from the lighting device 70 provides a shadow on the engraved marks of the drugs M, thereby making the engraved marks easier to recognize. In addition, the illumination light brightens the drugs M, making it easier to recognize the colors of the drugs M and the shapes of the drugs M.

### [Actions and Effects of Embodiment]

The imaging assisting apparatus 10 according to the embodiment may achieve the following actions and effects.

[1]

The imaging assisting apparatus 10 includes: the placing member 12 in which the drugs M contained in the packaging bag P are placed; and the leg member 14 and the light suppressing member 16 each having a structure that extends from the placing member 12. The leg member 14 has a structure that extends toward the side opposite to the placing surface 30 of the placing member 12 where the packaging bag P is placed. The light suppressing member 16 has a structure that extends to the side opposite to the placing surface 30 of the placing member 12 where the packaging bag P is placed, and has a structure of facing the leg member 14. As a result, in imaging of the drugs M contained in the packaging bag P placed in the placing member 12, the light suppressing member 16 blocks at least part of the environmental light directed to the surface of the packaging bag P, thereby suppressing reflection of environmental light on the surface of the packaging bag P.

[2]

The light suppressing member 16 includes the first side surface member 16B, the second side surface member 16C, and the upper surface member 16D, each of which covers a part of the circumference of the placing surface 30. Together with the leg member 14, the light suppressing member 16 provides a structure that covers the entire circumference of the placing surface 30 of the placing member 12. This enhances the function of blocking environmental light directed toward the surface of the packaging bag P.

[3]

The imaging assisting apparatus 10 is installed on the plane parallel to the horizontal plane. In imaging the drugs M contained in the packaging bag P, the leg member 14 is directed downward, the light suppressing member 16 is directed upward, and the placing surface 30 of the placing member 12 is directed in a direction having a vertically upward component. This makes it easy to adjust the imaging range in a case where the drugs M is imaged.

[4]

In a case where the packaging bag P containing the drugs M is placed to the placing member 12, the imaging assisting apparatus 10 is installed on the plane parallel to the horizontal plane in a state where the distal end 14A of the leg member 14 and the distal end 16A of the light suppressing member 16 are directed upward. Thereby, the packaging bag P placed on the placing member 12 can be easily recognized.

### [First Modification]

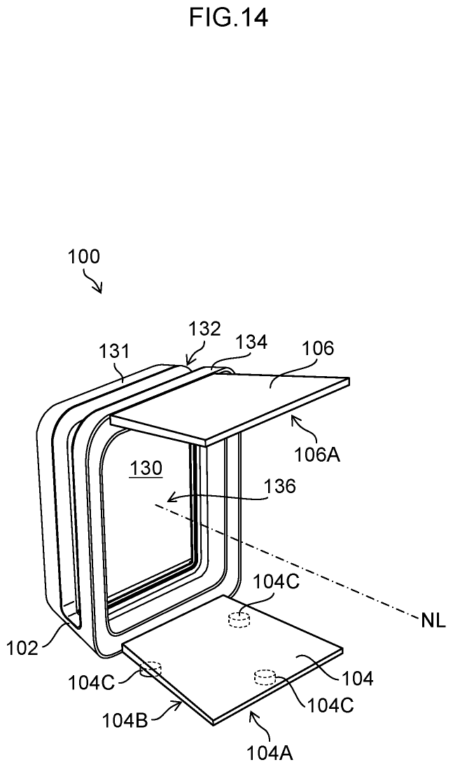

FIG. 14 is a perspective view of an imaging assisting apparatus according to a first modification. FIG. 14 shows a state in which an imaging assisting apparatus 100 is installed on a plane parallel to the horizontal plane.

The imaging assisting apparatus 100 according to the first modification includes a flat plate-shaped light suppressing member 106. The light suppressing member 106 shown in FIG. 14 does not have the first side surface member 16B and the second side surface member 16C of the light suppressing member 16 shown in FIG. 1, and has only the upper surface member 16D.

Further, the imaging assisting apparatus 100 has a structure in which a flat plate-shaped leg member 104 is separated from the light suppressing member 106. In FIG. 14, rubber legs 104C are attached to an outer surface 104B of the leg member 104. The number of rubber legs 104C may be three or more. As long as a stable installation state of the imaging assisting apparatus 100 is ensured when the imaging assisting apparatus 100 is installed on the workbench, the outer surface 104B of the leg member 104 may be a flat surface to which the rubber leg 104C is not attached.

A placing member 102 provided in the imaging assisting apparatus 100 has the same configuration as the placing member 12 shown in FIG. 1, etc. In other words, the placing member 102 includes: a placing surface member 131 having a placing surface 130; and a placement facing surface member 134 having a placement facing surface 132. The placement facing surface member 134 has a second opening 136 penetrating in the thickness direction.

In the imaging assisting apparatus 100 installed on the plane parallel to the horizontal plane, the direction of the normal line NL of the placing surface 130 is provided to have a horizontal component. In addition, the light suppressing member 106 extends from at least a part of the placing member 102 in a slightly upward direction with respect to the direction of the normal line NL of the placing surface 130.

In addition, in the imaging assisting apparatus 100 installed on the plane parallel to the horizontal plane, the leg member 104 is disposed on the side opposite to the light suppressing member 106 across the placing member 102, and is disposed at a position facing the light suppressing member 106.

The imaging assisting apparatus 100 may include a reinforcing member that connects the leg member 104 and the light suppressing member 106. For example, the imaging assisting apparatus 100 may include a reinforcing member that connects a distal end 104A of the leg member 104 and a distal end 106A of the light suppressing member 106. The reinforcing member may be disposed at a position closer to the proximal end than the distal end 104A of the leg member 104 and the distal end 106A of the light suppressing member 106.

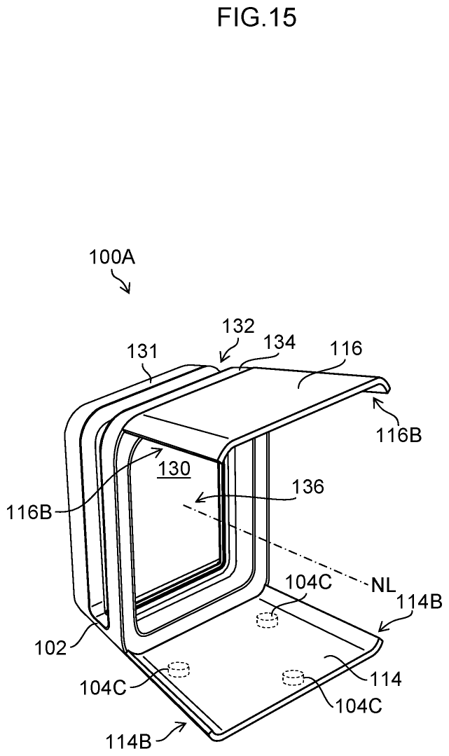

The imaging assisting apparatus 100 may have a structure in which the light suppressing member 106 can be freely folded toward the placing member 102. Likewise, the imaging assisting apparatus 100 may have a structure in which the leg member 104 can be freely folded toward the placing member 102. The same applies to an imaging assisting apparatus 100A shown in FIG. 15.

FIG. 15 is a perspective view of an imaging assisting apparatus according to another aspect of the first modification. A leg member 114 of the imaging assisting apparatus 100A shown in FIG. 15 is different in its shape from the leg member 104 included in the imaging assisting apparatus 100 shown in FIG. 14.

The leg member 114 shown in FIG. 15 has a structure in which both ends of a flat plate are bent. Ends 114B of the leg member 114, in a direction perpendicular to the direction in which the leg member 114 extends, each have a component directed toward a light suppressing member 116.

Likewise, the light suppressing member 116 has a structure in which both ends of a flat plate are bent. Ends 116B of the light suppressing member 116, in a direction perpendicular to the direction in which the light suppressing member 116 extends, each have a component directed toward the leg member 114.

### [Action and Effect of First Modification]

The imaging assisting apparatus 100 according to the first modification blocks at least part of the environmental light emitted from the side of the light suppressing member 116 to the packaging bag P containing the drugs M. This suppresses the reflection of the environmental light on the surface of the packaging bag P in imaging of the drugs M.

### [Second Modification]

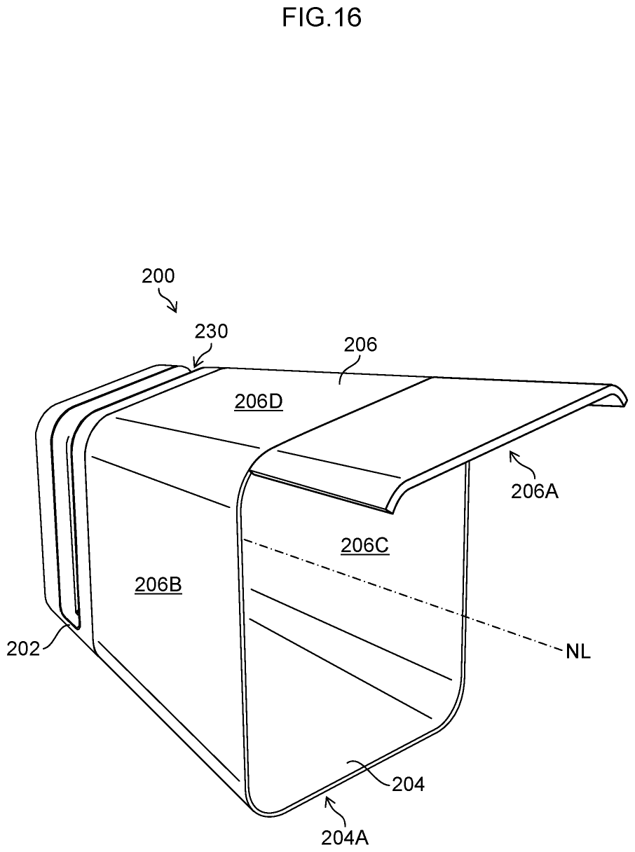

FIG. 16 is a perspective view of an imaging assisting apparatus according to a second modification. An imaging assisting apparatus 200 according to the second modification has a structure in which the length of a light suppressing member 206 is longer than the length of a leg member 204 in the direction of the normal line NL of a placing surface 230.

In other words, the imaging assisting apparatus 200 has a structure in which, in the direction of the normal line NL of the placing surface 230, a distance from a placing member 202 to a distal end 206A of the light suppressing member 206 is longer than a distance from a placing member 202 to a distal end 204A of the leg member 204, and the light suppressing member 206 extends longer than the leg member 204 in the distal direction.

FIG. 16 illustrates an example of an aspect having a structure in which, of a first side surface member 206B, a second side surface member 206C, and an upper surface member 206D provided in the light suppressing member 206, the length of the upper surface member 206D is longer than the length of the leg member 204 in the direction of the normal line NL of the placing surface 230.

Regarding the light suppressing member 206 of the imaging assisting apparatus 200, an extension member may be attached to the light suppressing member 206 having the same length as the leg member 204 in the direction of the normal line NL of the placing surface 230, so as to obtain the structure in which the light suppressing member is longer than the leg member 204. Also, in the light suppressing member 206 shown in FIG. 16, the first side surface member 206B and the second side surface member 206C may be extended to the same length as the upper surface member 206D.

### [Action and Effect of Second Modification]

The imaging assisting apparatus 200 according to the second modification enhances the effect of blocking at least part of the environmental light emitted from above in a case where the imaging assisting apparatus 200 is installed on a plane parallel to the horizontal plane. This enhances the suppression of reflection of environmental light on the surface of the packaging bag P.

### [Third Modification]

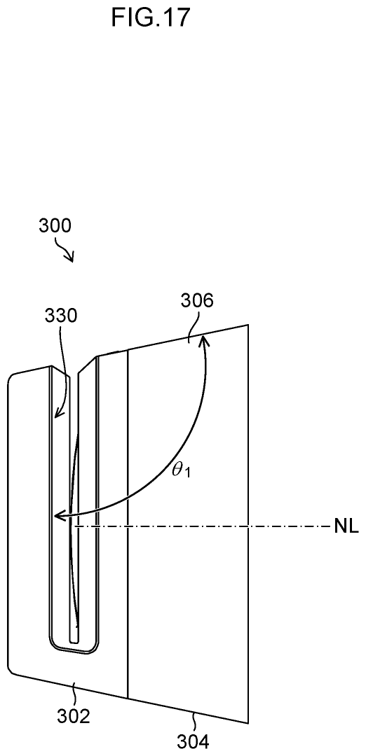

FIG. 17 is a schematic diagram of an imaging assisting apparatus according to a third modification. FIG. 17 shows a schematic diagram corresponding to a right side view of an imaging assisting apparatus 300 according to the third modification. The imaging assisting apparatus 300 according to the third modification has a structure in which an angle θ₁ formed between a placing surface 330 provided in a placing member 302 and a light suppressing member 306 is an obtuse angle exceeding 90 degrees. Examples of a case where the placing surface 330 is used as a reference, include a case where the direction of the normal line NL of the placing surface 330 is used as a reference.

### [Action and Effect of Third Modification]

In a case where the imaging assisting apparatus 300 according to the third modification is installed on a plane parallel to the horizontal plane, the light suppressing member 306 is directed upward with respect to the horizontal plane. This makes it easier to adjust the imaging range when the drugs M are imaged.

In the imaging assisting apparatus 300 according to the third modification, an aspect in which the placing surface 330 is perpendicular to a leg member 304 may also make it possible to obtain the above actions and effects. Note that the term “perpendicular” is not limited to “strictly perpendicular”, and may include an “substantially perpendicular” that can be regarded as perpendicular from the viewpoint of actions and effects.

### [Fourth Modification]

As a fourth modification, a modification example of the fixing structure 50 in FIG. 6, etc. is shown. A fixing structure described below is to fix the packaging bag P containing the drugs M and the drugs M contained in the packaging bag P. The fixing structure may suppress movement of the drugs M inside the packaging bag P in a case where the drugs M contained in the packaging bag P is imaged.

### [First Modification of Placing Surface]

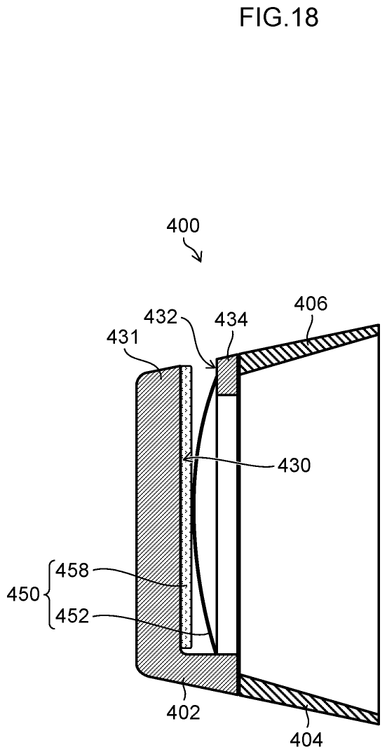

FIG. 18 is an explanatory diagram of a first modification of the placing surface. FIG. 18 shows a vertical cross-sectional view of an imaging assisting apparatus 400 according to the fourth modification. The imaging assisting apparatus 400 has the same configuration as the imaging assisting apparatus 10 shown in FIG. 1, etc. in that the apparatus 400 includes a placing member 402, a leg member 404, and a light suppressing member 406.

The imaging assisting apparatus 400 includes a fixing part 450 for the placing member 402. The fixing part 450 includes a leaf spring 452 and a cushioning member 458. The leaf spring 452 is disposed on a placement facing surface 432 of a placement facing surface member 434 in the same manner as the leaf spring 52 shown in FIG. 6, etc. The leaf spring 452 is supported by a supporting member having the same structure and arrangement as the leaf spring supporting member 56 shown in FIG. 6, etc. In FIG. 18, an illustration of a supporting member corresponding to the leaf spring supporting member 56 shown in FIG. 6, is omitted.

The fixing part 450 may include a transparent elastic plate having a size and arrangement that covers the entire surface of a placing surface 430, instead of the leaf spring 452. Examples of the material for the transparent elastic plate include acrylic resin.

The cushioning member 458 is disposed on the placing surface 430 of a placing surface member 431. The cushioning member 458 may have a shape and size corresponding to one packaging of the packaging bag P, and may be disposed at a position enabling to cover the entire surface of one packaging of the packaging bag P. Alternatively, the cushioning member 458 that is smaller than one packaging of the packaging bag P may be placed on a part of the placing surface 430.

The cushioning member 458 may be a member that can deform according to the shape of the drugs M when the leaf spring 452 presses the packaging bag P. Examples of the material for the cushioning member 458 include polyurethane.

Here, the fixing part 450 described in the embodiment is an example of a movement suppressing mechanism that suppresses movement of the drugs contained in the packaging bag. The same applies to the fixing part 450, etc. described below. The leaf spring 452 described in the embodiment is an example of a pressing member and an example of an elastic member.

In the imaging assisting apparatus 400 to which the placing surface 430 according to the first modification is applied, the position of the drugs M is fixed due to the deformation of the cushioning member 458. Thereby, movement of the drugs M is suppressed. In particular, falling of the drugs M is suppressed in imaging.

### [Second Modification of Placing Surface]

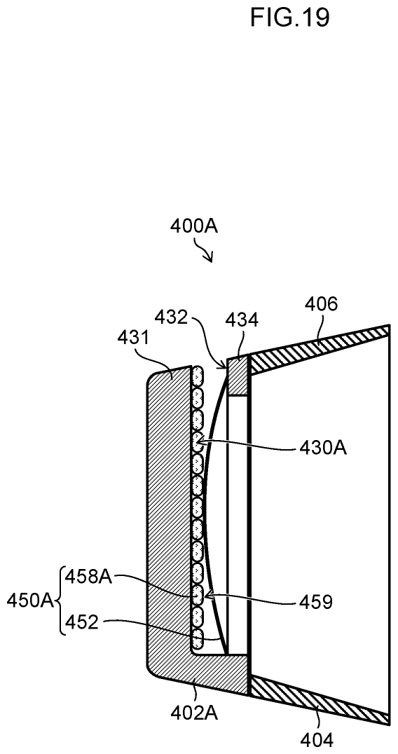

FIG. 19 is an explanatory diagram of a second modification of the placing surface. FIG. 19 shows a vertical cross-sectional view of an imaging assisting apparatus 400A. Instead of the cushioning member 458 shown in FIG. 18, a fixing part 450A shown in FIG. 19 includes a cushioning member 458A formed to have convex shapes 459. In other words, a placing member 402A has the cushioning member 458A disposed for a placing surface 430A.

The size and arrangement of each convex shape 459 of the cushioning member 458A can be defined according to the size and number of the drugs M to be imaged. The material of the convex shape 459 may be hard or may be flexible. Note that the convex shape 459 described in the embodiment is an example of protrusions formed on the background surface.

In the imaging assisting apparatus 400A to which the placing surface 430A according to the second modification is applied, the drugs M are pressed against the convex shapes 459 of the cushioning member 458A, and the position of the drugs M is fixed. Thereby, movement of the drugs M is suppressed. In particular, falling of the drugs M is suppressed in imaging.

### [Third Modification of Placing Surface]

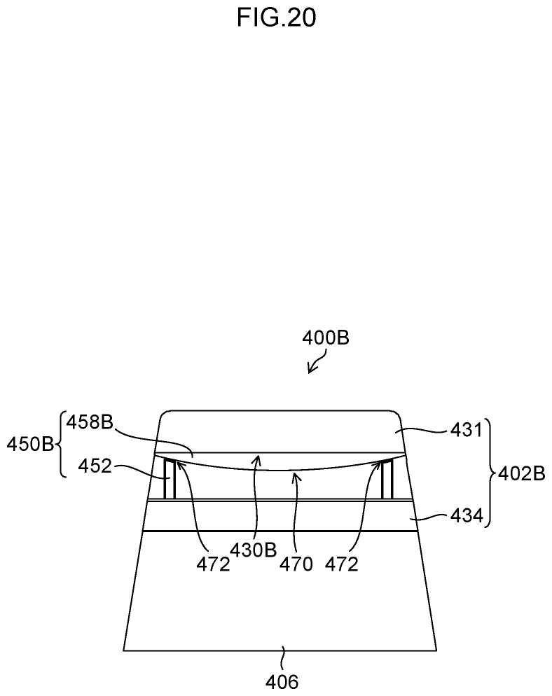

FIG. 20 is an explanatory diagram of a third modification of the placing surface. FIG. 20 shows a top view of an imaging assisting apparatus 400B. The imaging assisting apparatus 400B includes a fixing part 450B. The fixing part 450B includes a cushioning member 458B instead of the cushioning member 458 shown in FIG. 18. In other words, a placing member 402B has a cushioning member 458B disposed for a placing surface 430B.

The cushioning member 458B has a shape in which a central part 470 of the placing surface 430B is relatively thick, and contact positions 472 with the leaf spring 452 are relatively thin. The material of the cushioning member 458B may be hard or may be flexible. Note that the shape of the cushioning member 458B described in the embodiment is an example of a shape in which a center is convex with respect to an edge.

In the imaging assisting apparatus 400B to which the placing surface 430B according to the third modification is applied, the packaging bag P is pressed against the central part 470 of the cushioning member 458B, and the position of the drugs M contained in the packaging bag P is fixed. Thereby, movement of the drugs M is suppressed. In particular, falling of the drugs M is suppressed when the drugs M are imaged.

### [Fourth Modification of Placing Surface]

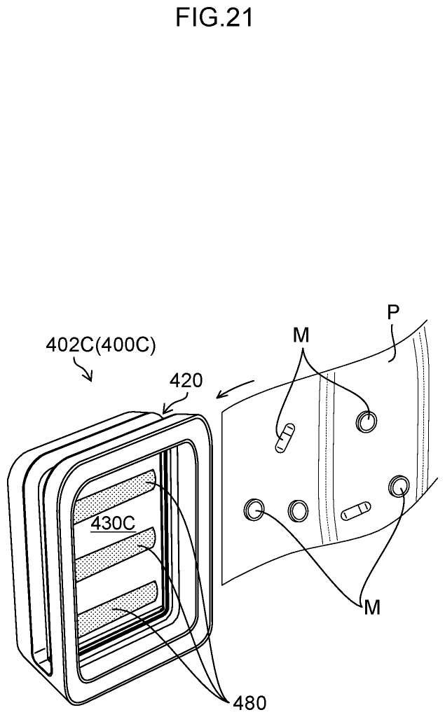

FIG. 21 is an explanatory diagram of a fourth modification of the placing surface. FIG. 21 shows a placing member 402C of an imaging assisting apparatus 400C, and illustration of a leg member and a light suppressing member are omitted. The imaging assisting apparatus 400C may have the leg member 14 and the light suppressing member 16 shown in FIG. 1, or may have the leg member and the light suppressing member according to any one of the modifications.

A placing surface 430C has convex parts 480 which respectively extend in the lateral direction which is a direction in which a groove 420 penetrates the placing member 12 in FIG. 21. FIG. 21 illustrates an example of an aspect in which the convex parts 480 are formed and arranged in a direction perpendicular to the direction in which each convex part 480 extends.

When the packaging bag P containing the drugs M is inserted into the groove 420 in the direction in which the groove 420 penetrates, the drugs M are held between the adjacent convex parts 480. This suppresses falling of the drugs M, which is a movement of the drugs M in the direction in which the groove 420 penetrates the placing member 12.

The normal lines NL on the non-planar placing surface shown in the fourth modification may have a representative normal line representing the normal lines defined by the placing surface. Example of the representative normal lines includes the normal line at the position of the center of gravity of the placing surface.

### [Fifth Modification]

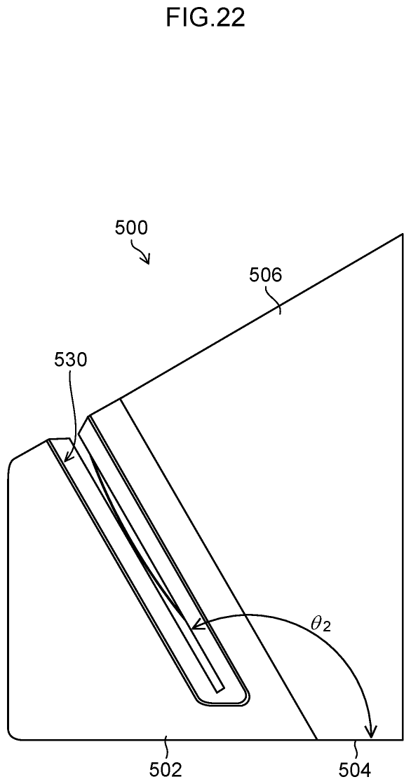

FIG. 22 is an explanatory diagram of an imaging assisting apparatus according to a fifth modification. FIG. 22 shows a right side view of an imaging assisting apparatus 500. The imaging assisting apparatus 500 has a structure in which an angle θ₂ between the direction in which a leg member 504 extends and a placing surface 530 provided in a placing member 502, is 120 degrees or more.

In a case where the imaging assisting apparatus 500 is installed on a plane parallel to the horizontal plane in state where the leg member 504 is directed downward, the placing surface 530 may be sufficiently inclined in such a manner that the imaging range can be easily adjusted when the drugs M are imaged. Here, the reference sign 506 in FIG. 22 designates a light suppressing member.

### [Other Modifications]

FIG. 1, etc. illustrate the imaging assisting apparatus 10 having a truncated quadrangular pyramid shape as a whole. However, the imaging assisting apparatus 10 may have a truncated cone shape, a quadrangular prism shape, or a cylindrical shape.

In other words, FIG. 1, etc. illustrate the imaging assisting apparatus 10 having a structure in which the leg member 14 and the light suppressing member 16 radially extend with respect to the normal line NL passing through the center of gravity of the placing surface 30. However, the imaging assisting apparatus 10 may have a structure in which at least one of the leg member 14 and the light suppressing member 16 extends parallel to the normal line NL of the placing surface 30.

The imaging assisting apparatus may have a camera fixing member that fixes the camera to a position on the opposite side of the placing surface 30 of the first opening 22. The camera fixing member may be configured integrally with the imaging assisting apparatus, or may be freely detachable from the imaging assisting apparatus.

In the embodiments of the present invention described above, it is possible to change, add, or delete constituent elements as appropriate without departing from the scope of the present invention. The present invention is not limited to the embodiments described above, and many modifications are possible within the technical concept of the present invention by those skilled in the art. Further, the embodiments, modifications, and application examples may be combined as appropriate.

### REFERENCE SIGNS LIST

10 imaging assisting apparatus

12 placing member

12A back surface

14 leg member

14A distal end of leg member

14B outer surface

16 light suppressing member

16A distal end of light suppressing member

16B first side surface member

16C second side surface member

16D upper surface member

20 groove

22 first opening

30 placing surface

31 placing surface member

32 placement facing surface

34 placement facing surface member

36 second opening

36A interior of second opening

40 marker

40A end

40B corner part

40C corner part

40D end

41 marker

41A end

41D end

42 marker

50 fixing structure

52 leaf spring

54 contacting member

56 leaf spring supporting member

70 lighting device

100 imaging assisting apparatus

100A imaging assisting apparatus

102 placing member

104 leg member

104A distal end

104B outer surface

104C rubber leg

106 light suppressing member

106A distal end

114 leg member

114B end of leg member

116 light suppressing member

116B end of light suppressing member

130 placing surface

131 placing surface member

132 placement facing surface

134 placement facing surface member

136 second opening

200 imaging assisting apparatus

202 placing member

204 leg member

204A distal end of leg member

206 light suppressing member

206A distal end of light suppressing member

206B first side surface member

206C second side surface member

206D upper surface member

230 placing surface

300 imaging assisting apparatus

302 placing member

304 leg member

306 light suppressing member

330 placing surface

400 imaging assisting apparatus

400A imaging assisting apparatus

400B imaging assisting apparatus

400C imaging assisting apparatus

402 placing member

402A placing member

402B placing member

402C placing member

420 groove

430 placing surface

430A placing surface

430B placing surface

430C placing surface

431 placing surface member

432 placement facing surface

434 placement facing surface member

450 fixing part

450A fixing part

450B fixing part

452 leaf spring

458 cushioning member

458A cushioning member

458B cushioning member

459 convex shape

470 central part of placing surface

472 contact position

480 convex part

500 imaging assisting apparatus

502 placing member

504 leg member

506 light suppressing member

530 placing surface

C camera

M drug

M1 vertex marker

M1A vertex marker

M2 vertex marker

M2A vertex marker

M3 vertex marker

M3A vertex marker

M4 vertex marker

M4A vertex marker

MP mobile terminal apparatus

NL normal line of placing surface

P packaging bag

V1 vertex

V2 vertex

V3 vertex

V4 vertex

V11 vertex

V12 vertex

V13 vertex

V14 vertex

V1A vertex

V1B vertex

V1C vertex

V1D vertex

θ₁ angle formed by placing surface and light suppressing member

θ₂ angle formed by placing surface and leg member

What is claimed is:

1. An imaging assisting apparatus, comprising:
a first member in which a packaging bag containing a drug is placed, and has a first surface disposed on a side opposite to a surface to be imaged of the packaging bag;
a second member which extends from the first member toward a side opposite to the first surface where the packaging bag is placed, and is configured to suppress incidence of environmental light on the packaging bag placed in the first member; and
a third member which extends from the first member toward the side opposite to the first surface where the packaging bag is placed, and is disposed on a side opposite to the second member across the first member.

2. The imaging assisting apparatus according to claim 1, wherein
the third member has a leg part to be used in a case where the imaging assisting apparatus is installed, and
the leg part is configured in such a manner that the imaging assisting apparatus may be installed in an attitude in which: a normal line of the first surface has a horizontal component; and a direction in which the second member extends has a component in a direction of the normal line.

3. The imaging assisting apparatus according to claim 1, wherein
the second member includes a side surface member extending in a direction perpendicular to a direction in which the second member extends.

4. The imaging assisting apparatus according to claim 3, wherein
in the second member, an end of the side surface member is joined to an end of the third member in a direction perpendicular to a direction in which the third member extends.

5. The imaging assisting apparatus according to claim 4, wherein
a distal end of the second member is disposed farther from the first member than a distal end of the third member.

6. The imaging assisting apparatus according to claim 1, wherein
the second member has a structure in which an angle formed between the second member and the first surface is more than 90 degrees.

7. The imaging assisting apparatus according to claim 1, wherein
the third member has a structure in which an angle formed between the third member and the first surface is more than 90 degrees.

8. The imaging assisting apparatus according to claim 1, wherein
the third member has a structure in which an angle formed between the third member and the first surface is 120 degrees or more.

9. The imaging assisting apparatus according to claim 1, wherein
the first member includes a movement suppressing mechanism configured to suppress movement of the drug contained in the packaging bag.

10. The imaging assisting apparatus according to claim 9, wherein
the movement suppressing mechanism includes a pressing member configured to press the packaging bag toward the first surface.

11. The imaging assisting apparatus according to claim 10, wherein
the pressing member is disposed on a first facing surface which faces the first surface.

12. The imaging assisting apparatus according to claim 11, wherein
the first facing surface has: a shape corresponding to a planar shape of the first surface; and a through hole formed at a position corresponding to the first surface, and the pressing member is disposed around the through hole of the first facing surface.

13. The imaging assisting apparatus according to claim 10, wherein
the pressing member is made using an elastic member.

14. The imaging assisting apparatus according to claim 10, wherein
the movement suppressing mechanism includes a cushioning member disposed at a position where the packaging bag is pressed on the first surface by the pressing member.

15. The imaging assisting apparatus according to claim 9, wherein
the first surface has a plurality of protrusions.

16. The imaging assisting apparatus according to claim 9, wherein
the first surface has a shape in which a center is convex with respect to an edge.

17. The imaging assisting apparatus according to claim 9, wherein
the first surface has a plurality of convex parts which respectively extend in a direction in which the packaging bag is inserted into the first member, and
the plurality of convex parts are arranged to be spaced apart from each other, along a direction that is parallel to the first surface and perpendicular to a direction in which the plurality of convex parts extend.

18. An imaging assisting method for assisting imaging of a drug using an imaging assisting apparatus,
wherein the imaging assisting apparatus includes: a first member in which a packaging bag containing the drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward a side opposite to the first surface where the packaging bag is placed, and is disposed on a side opposite to the second member across the first member,
the imaging assisting method comprising:
placing the packaging bag containing the drug, in the first member of the imaging assisting apparatus installed in an attitude where the first surface is directed in a vertically upward direction;
fixing a position of the packaging bag placed on the first surface; and
changing an attitude of the imaging assisting apparatus in which the packaging bag is fixed to the first surface, from the attitude where the first surface is directed in the vertically upward direction, to an attitude where the first surface is directed in a direction intersecting the vertically upward direction, to assist the imaging of the drug.

19. An imaging assisting method for assisting imaging of a drug using an imaging assisting apparatus,
wherein the imaging assisting apparatus includes: a first member in which a packaging bag containing the drug is placed, and has a first surface disposed on a side opposite to a surface to be imaged of the packaging bag; a second member which extends from the first member toward a side opposite to the first surface where the packaging bag is placed, and is configured to suppress incidence of environmental light on the packaging bag placed in the first member; and a third member which extends from the first member toward a side opposite to the first surface where the packaging bag is placed, and is disposed on a side opposite to the second member across the first member,
the imaging assisting method comprising:
causing at least a part of the third member to function as a leg part; and
assisting the imaging of the drug, using the imaging assisting apparatus installed in an attitude where the first surface is directed in a direction intersecting a vertically upward direction.
